(19) United States
(12) Patent Application Publication
(10) Pub. No.: US 2007/0201608 A1
(43) Pub. Date: Aug. 30, 2007

(54) Method for testing a fuel rod cladding tube and associated device

(75) Inventors: Kilian Model, Buttenheim (DE); Christian Muller, Bamberg (DE)

Correspondence Address: LERNER GREENBERG STEMER LLP, P O BOX 2480, HOLLYWOOD, FL, 33022-2480, US

(73) Assignee: Areva NP GmbH

(21) Appl. No.: 11/711,796

(22) Filed: Feb. 27, 2007

(30) Foreign Application Priority Data
Feb. 27, 2006 (DE) 10 2006 009 502.2

(51) Int. Cl. G21C 3/00

(52) U.S. Cl. 376/417

(57) ABSTRACT

A method for testing a fuel rod cladding tube enables an operation-oriented assessment of its corrosion behavior. The fuel rod cladding tube is partly immersed in a surrounding medium and heated from inside. An electrode potential of the fuel rod cladding tube is measured relative to a reference electrode and measured data are used to extrapolate material characteristics of the fuel rod cladding tube, in particular its corrosion characteristics. A device for carrying out the method includes a pressure vessel to be filled with a surrounding medium and having an aperture opening in a vessel wall for insertion of the fuel rod cladding tube into the pressure vessel through the aperture opening. A heating apparatus is disposed in the interior of the fuel rod cladding tube and an electrically insulating sealing body is disposed between the fuel rod cladding tube and the vessel wall.

### CROSS-REFERENCE TO RELATED APPLICATION

This application claims the priority, under 35 U.S.C. §119, of German Patent Application DE 10 2006 009 502.2, filed Feb. 27, 2006; the prior application is herewith incorporated by reference in its entirety.

### BACKGROUND OF THE INVENTION

### Field of the Invention

The invention relates to a method for testing a fuel rod cladding tube. The invention furthermore relates to a device suitable for carrying out the method.

The fuel assemblies of a nuclear reactor typically include a bundle of fuel rods. Each of the fuel rods has a fuel rod cladding, also referred to as a fuel rod cladding tube or cladding tube, which forms an outer enclosure containing enriched nuclear fuel, for example in the form of sintered uranium dioxide pellets, in its interior. The fuel rod cladding is intended to separate the nuclear fuel from coolant flowing around the fuel assemblies or the fuel rods and to prevent fission products produced in nuclear fission from entering the coolant or from coming into direct contact therewith.

In water-moderated nuclear reactors, the fuel rod cladding tubes are usually made of zirconium or of a zirconium alloy. In particular, it is possible to use Zircaloy alloys which, besides zirconium as a main constituent, can also include small amounts of tin, iron, nickel, chromium or niobium. Zirconium is a preferred material in the production of fuel rod claddings primarily for its comparatively low absorption cross sections for neutrons or, in other words, for its high neutron permeability, but also due to its high temperature resistance and good thermal conductivity.

Since, during operation of a nuclear reactor, the fuel rods are continuously exposed to the surrounding cooling medium which includes, inter alia, oxidizing constituents, an increase in corrosion of the Zircaloy surfaces is inevitable over the course of time. As a result, it is possible that the structural characteristics of the cladding tube material may change. Corrosion is therefore one of the processes limiting the duration of use of the fuel assemblies in the reactor to about three to five years.

It would be desirable to gather well-founded findings and heuristic empirical values with respect to material characteristics and to corrosion behavior of possible cladding tube materials under the operational conditions that are to be expected, even before a fuel assembly is put to its intended use in the nuclear reactor.

### SUMMARY OF THE INVENTION

It is accordingly an object of the invention to provide a method for testing a fuel rod cladding tube and a device suitable for carrying out the method, which overcome the hereinafore-mentioned disadvantages of the heretofore-known methods and devices of this general type and which enable an operation-oriented assessment of corrosion characteristics of the fuel rod cladding tube.

With the foregoing and other objects in view there is provided, in accordance with the invention, a method for testing a fuel rod cladding tube. The method comprises partly immersing the fuel rod cladding tube in a surrounding medium, heating the fuel rod cladding tube from inside the fuel rod cladding tube, and measuring an electrode potential of the fuel rod cladding tube relative to a reference electrode and providing measured data. Material characteristics, namely corrosion characteristics, of the fuel rod cladding tube are inferred or extrapolated using the measured data.

The invention is based on the finding that the extent of the corrosion is mainly determined by the nature of the material, the cladding tube temperature and the chemical composition of the surrounding cooling medium. In other words: the invention proceeds from the consideration that the corrosion behavior of a fuel rod cladding tube during reactor operation is influenced to a particular degree by the electrochemical processes on its surface, that is to say by the electrochemical interaction with the surrounding cooling medium. It was recognized in particular that even remarkably small changes in the chemical composition of the cooling medium can subtly trigger measurable corrosive effects and structural changes of the cladding tube material. A particularly sensitive indicator of such effects is the electrode potential of the fuel rod cladding tube, which forms an electrode in a liquid or gaseous surrounding medium, with respect to a reference electrode which is likewise immersed in the surrounding medium and is disposed at a distance from the measurement electrode. Therefore, it is the electrochemical potential or the potential difference between the two electrodes, which is influenced by the ionic conduction in the surrounding medium taking place between them and by processes at phase interfaces, that is measured. In the case of a liquid surrounding medium having moving charge carriers (ions) dissolved therein, it is also referred to as an electrolyte.

In accordance with the concept on which the invention is based, the corrosion potentials then continue to be measured not at the fuel rod cladding tube that is in operation, i.e. which is installed in the reactor and is filled with nuclear fuel, but in the manner of a simulation at a fuel rod cladding tube which is provided as a test object or as a unit under test in a measurement device suitable therefor or in a test stand. In this case, firstly the operational surrounding conditions which are important to the assessment of the corrosion behavior can be modeled relatively easily and secondly, in particular if it is primarily the influence of the coolant chemistry that matters, there is typically no need to fill the cladding tube with radioactive nuclear fuel. This significantly facilitates the realization of systematic test series with respect to the necessary safety provisions and official regulations, etc. By varying the experiment parameters, a series of operational scenarios can therefore be “played out” comparatively easily and without constituting any risk to the surrounding area or to the operating staff responsible for the test stand, which would not be practically possible for real reactor operation, even if only due to regulatory requirements.

It has moreover been recognized that a particularly operation-oriented assessment of the corrosion behavior of the respective cladding tube can be accomplished if the heating of the cladding tube which, in real operation, is caused by the nuclear fuel heating up, is instead effected by a heating apparatus mounted in the tube interior. This means that the measurement of the electrode potential also takes into account the transfer of heat from the interior of the cladding tube to the external surrounding medium.

In accordance with another mode of the invention, the chemical composition of the surrounding medium is advantageously chosen such that it is the same as, or similar to, the composition of a cooling medium in a nuclear reactor.

In accordance with a further mode of the invention, in particular, water or steam is expediently used as the surrounding medium into which one or more gases are introduced that are also present or dissolved in the cooling medium during operation of a nuclear reactor or which can occur during specific operational states. A systematic variation of the chemical composition of the surrounding medium and application of different gases can be used to detect, through the use of measurement technology, the influence of different water chemistry conditions on the material corrosion and to evaluate and assess it using the recorded measured data. These findings can then be appropriately taken into account in the interpretation, conception, planning and execution of the cladding tubes per se and also, if appropriate, of further reactor components and in the choice of operational parameters, etc.

The gases introduced into the surrounding medium may, for example, be hydrogen (H₂), oxygen (O₂), nitrogen (N₂) or argon (Ar). Other additives, for example liquids or soluble solids or emulsions, etc. can also be added to the surrounding medium as an alternative or additionally.

In accordance with an added mode of the invention, in order to create particularly realistic simulation conditions, the pressure and the temperature of the surrounding medium in the pressure vessel are preferably selected such that they correspond to the operational conditions in the reactor pressure vessel of a pressurized water reactor or in the reactor well or pit of a boiling water reactor. In particular, the corrosion processes in a boiling water reactor are of interest, so that the operational conditions prevailing therein are advantageously selected.

In accordance with an additional mode of the invention, in this case, the surrounding medium advantageously does not stand still in the pressure vessel of the test stand, but flows through it. A flow between an inlet side and an outlet side is expediently selected in such a way that it recreates flow conditions in the reactor pit of a nuclear reactor in terms of throughput rate, flow direction relative to the fuel rod cladding tube and, if appropriate, with respect to other criteria.

In accordance with yet another mode of the invention, for measuring purposes, the heating power of the heating apparatus heating the fuel rod cladding tube from inside is advantageously selected in such a way that it corresponds to the heating power which is released during operation of a nuclear reactor by a nuclear fuel located inside the fuel rod cladding tube. This creates particularly realistic and operation-oriented test conditions with respect to the temperature conditions and to the heat transfer through the fuel rod cladding tube.

With the objects of the invention in view, there is also provided a device for measuring an electrode potential of a fuel rod cladding tube. The device comprises a pressure vessel to be filled with a surrounding medium. The pressure vessel has a vessel wall with an aperture opening formed in the vessel wall for insertion of the fuel rod cladding tube through the aperture opening into the pressure vessel. A heating apparatus is to be disposed in an interior of the fuel rod cladding tube. An electrically insulating sealing body is to be disposed between the fuel rod cladding tube and the vessel wall.

Therefore, in the case of this construction, the fuel rod cladding tube is only partly immersed, after being inserted, in the pressure-carrying and temperature-carrying interior of the pressure vessel which is filled with surrounding medium, while the section of the fuel rod cladding tube which protrudes to the outside can be accessed easily even during the simulation and measurement process. The heating apparatus provided for heating the fuel rod cladding tube can, in particular, be inserted into the tube from the outside and can, if required, be easily replaced without the pressure vessel (which is also referred to as an autoclave) having to be opened or dismantled for this purpose. The sealing body between the fuel rod cladding tube and the wall of the autoclave has a dual function: firstly, it seals off the interspace against the leaking of, in some instances highly-pressurized surrounding medium from the vessel interior and secondly, it serves for the electrical insulation of the fuel rod cladding tube from the circumjacent metallic components of the pressure vessel, which enables an undistorted, reliable measurement of the potential applied at the tube in the first place.

In accordance with another feature of the invention, the sealing body is an annular or hollow-cylindrical Teflon insert. It has been found that the polytetrafluoroethylene known as Teflon also meets requirements with respect to sealing action and electric insulation in an especially favorable way. Teflon is also decidedly reaction inert and resistant with respect to most acids, bases and other chemically aggressive additives which may possibly be added to the surrounding medium in the pressure vessel interior. Teflon also has a comparatively low coefficient of friction, which facilitates the insertion of the fuel rod cladding tube with simultaneous high sealing action. Due to the mechanical clamping action of the seal encasing, the fuel rod cladding tube sits securely and fixedly in the cutout of the pressure vessel. Further holding measures which, by virtue of their contact potentials, could lead to undesired potential changes in the cladding tube, are not necessary.

In accordance with a further feature of the invention, in order to also reliably rule out potential changes originating from the heating side, the electrical heating apparatus disposed in the tube interior is advantageously galvanically decoupled from the primary heating electric circuit through an isolating transformer or through a series connection of isolating transformers (potential-free heating).

In accordance with an added feature of the invention, the measurement device includes an electrical connecting contact for tapping off the electrode potential, which is fixed on the fuel rod cladding tube and is connected to a first input of a potential or voltage measurement appliance. The electrical connecting contact is advantageously fixed to that portion of the fuel rod cladding tube which protrudes out of the pressure vessel. It may, for example, be in the form of a releasable clamping contact. Furthermore, one or more reference electrodes, having respective connecting lines which are advantageously guided to the outside through aperture openings in the vessel wall, that are sealed off with temperature-resistant and electrically insulating plastic, are expediently disposed at a distance from the fuel rod cladding tube in the pressure vessel interior. They are connected to a second input of the potential or voltage measurement appliance positioned outside the pressure vessel. Therefore, what is measured is the electric voltage between the fuel rod cladding tube acting as a working electrode and one of the reference electrodes in each case.

In accordance with an additional feature of the invention, a cartridge heater which can be inserted into the fuel rod cladding tube in such a way that it can be replaced, preferably a high-power cartridge heater having a design output of approximately 75 watts/cm², is provided as the heating apparatus. A heat flux comparable to that during use of the fuel rod cladding tube in a nuclear reactor can thus be achieved.

In accordance with yet another feature of the invention, in order to avoid a “baking together” of the cartridge heater and the fuel rod cladding tube, even during a relatively long heating operation, a silver insert constructed in the manner of a hollow cylinder or a tube is advantageously disposed between the cartridge heater and the fuel rod cladding tube. This ensures a comparatively long cartridge heater service life. The high thermal conductivity of silver ensures a good heat transfer from the cartridge heater to the cladding tube to be heated.

In accordance with yet a further feature of the invention, the pressure vessel of the measurement configuration furthermore has a flow-side inlet and an outlet for the surrounding medium flowing around the fuel rod cladding tube. On the inlet side, an external pump applies the intended operational pressure to the surrounding medium which an external preheating apparatus brings to the intended inlet temperature. While the surrounding medium flows around the fuel rod cladding tube which is heated from inside, it heats up further and then leaves the pressure vessel through the outlet opening provided therefor.

In accordance with a concomitant feature of the invention, there is provided a number of temperature measuring sensors disposed in the interior of the pressure vessel in such a manner that they are distributed along the fuel rod cladding tube. The temperature measuring sensors are used to control the temperature profile of the medium. The temperature measuring sensors are preferably thermocouples. They are preferably disposed near the outflow in order to detect the influence of the cladding tube heating, i.e. the heat transfer to the surrounding medium.

The advantages gained by the invention are in particular that the corrosion potentials of fuel rod cladding tubes can be measured with great accuracy and while largely avoiding disturbing secondary effects under operation-oriented conditions, i.e. when heat is transferred to the surrounding high temperature cooling medium and given different chemical compositions of the cooling medium. Operation-oriented assessment of the (long-term) corrosion behavior of the cladding tubes is possible on the basis of the measured data ascertained in this way.

Other features which are considered as characteristic for the invention are set forth in the appended claims.

Although the invention is illustrated and described herein as embodied in a method for testing a fuel rod cladding tube and an associated device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a test and measurement device for a fuel rod cladding tube; and

FIG. 2 is a measured value diagram recorded with the aid of the test and measurement device.

### DESCRIPTION OF THE PREFERRED EMBODIMENTS

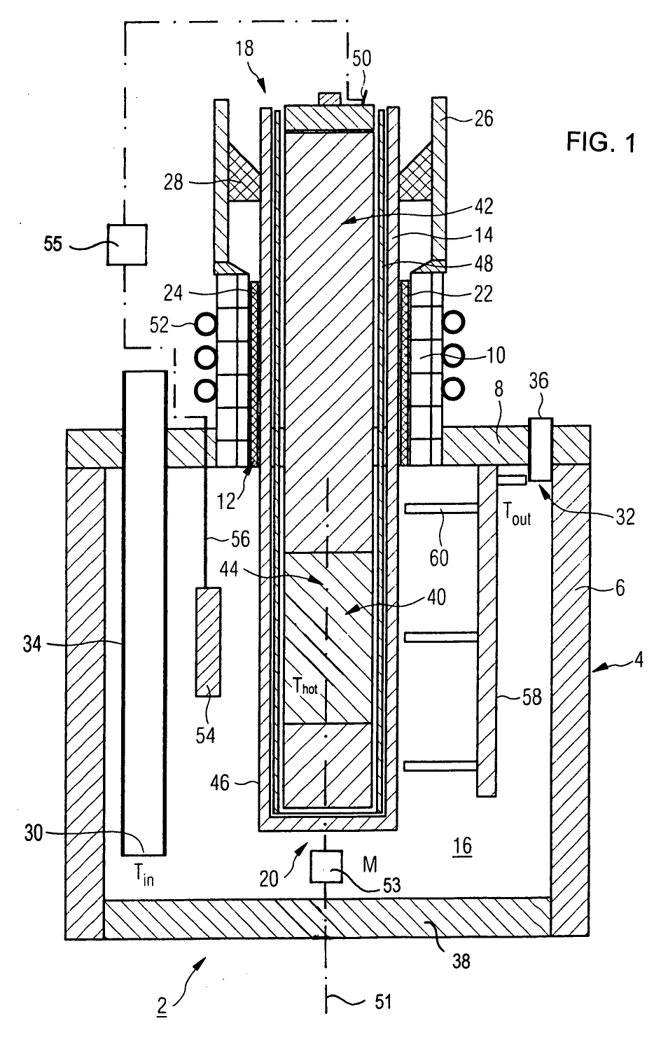

Referring now to the figures of the drawings in detail and first, particularly, to FIG. 1 thereof, there is seen a test and measurement device 2 which has a pressure vessel 4 (also referred to as an autoclave) having a pressure-stable and thermally insulating vessel wall 6 made of a high-alloy steel, in this case X6CrNiMoTi: 17-12-2. An insertion piece 10, protruding out over a cover plate 8, is provided on a top side of the pressure vessel 4. A fuel rod cladding tube 14 is able to be inserted through a cylindrical cutout 12 or aperture opening of the insertion piece 10, into a vessel interior 16 of the pressure vessel 4, to a measurement position shown in FIG. 1. In the exemplary embodiment, approximately half of the length of the fuel rod cladding tube 14, which is made of Zircaloy, is open at an upper end 18 and closed at a lower end 20, protrudes into the interior 16 of the pressure vessel 4. An upwardly adjoining section of the fuel rod cladding tube 14 is encased by the insertion piece 10, with a sealing body 24 being disposed between the fuel rod cladding tube 14 and an inner surface 22 of the insertion piece 10. The sealing body 24 is in the form of a hollow cylinder and is made of polytetrafluoroethylene, which is also known under the trademark Teflon. Firstly, this ensures a high sealing action which is stable even, in chemical terms, with respect to comparatively aggressive media in the vessel interior 16. Secondly, the fuel rod cladding tube 14 to be investigated is electrically insulated from the vessel wall 6 by the Teflon insert 24.

The inner diameter of the Teflon insert 24 is matched to the outer diameter of the fuel rod cladding tube 14 in such a manner that the fuel rod cladding tube 14 can be slid into the pressure vessel 4 comparatively easily and smoothly at room temperature, which is further supported by the low coefficient of friction of Teflon. A clamping action occurs as a consequence of operational heating up of the test device 2 and of the cladding tube 14 and as a consequence of the thermal expansion caused thereby and is used to fix the fuel rod cladding tube 14 securely in the insertion piece 10 during the investigation, without the need for further arresting measures. The insertion piece 10 is also adjoined, further upward, by a cylindrical upper portion 26 with inner electrically insulating fixtures 28 made of Teflon, which additionally stabilize the fuel rod cladding tube 14 at the upper end 18.

The pressure vessel 4 furthermore has an inlet 30 and an outlet 32 for a liquid or vaporous surrounding medium M which fills the vessel interior 16 completely during operation and in this case enters into electrochemical and thermal interaction with the fuel rod cladding tube 14. In the exemplary embodiment, the capacity of the pressure vessel is around 1.1 l. The chemical composition of the surrounding medium M is the same as the cooling medium in the reactor well or pit of a boiling water reactor, i.e. it includes mainly water to which various additives, for example in the form of dissolved gases as well, may be added for test purposes. During the test and measurement process, continuous flow around the fuel rod cladding tube 14 is provided at defined surrounding conditions, which are similar to those in a boiling water reactor. For this purpose, the surrounding medium M, which is continuously temperature-controlled and pressurized, is introduced into the vessel interior 16 through the inlet 30 and then flows out again through the outlet 32 after its interaction with the fuel rod cladding tube 14. The surrounding medium M has an inlet temperature Tᵢₙ of about 280° C. and a volumetric flow rate of approximately 7 to 8 l/h. The operational pressure in the vessel interior 16 is around 87 bar, but at most around 95 bar. Installation components and regulating units necessary to generate pressure, to preheat and to chemically prepare the surrounding medium M, are disposed outside the measurement device 2 and are not shown herein. Provision may be made to circulate the surrounding medium M.

In the exemplary embodiment, in each case one inlet tube 34 and one outlet tube 36 are guided through the vessel cover or cover plate 8 of the autoclave, with the inlet tube 34 being immersed significantly more deeply in the pressure vessel 4 than the outlet tube 36. The inlet 30 for the surrounding medium M therefore is approximately at the level of a vessel bottom 38, whereas the outflow, at the outlet 32, takes place near the vessel cover 8. Therefore, the flow in the vessel interior 16 has both a vertical as well as a horizontal component, which also approximately corresponds to the flow conditions in a boiling water reactor.

In order to detect and assess the corrosion behavior of the fuel rod cladding tube 14 under particularly realistic, application-oriented conditions, an electrical heating apparatus 40 is additionally disposed in the tube interior. The heating apparatus 40 is a cylindrical, high-power cartridge heater 42 (a so-called hotfinger) which can be inserted into the fuel rod cladding tube 14 from the freely-accessible upper end 18 of the cladding tube. In the region of a heating zone 44, a section of the fuel rod cladding tube 14 protruding into the pressure vessel 4 is heated by using a surface heating power of up to 75 W/cm². This creates a heat flow inside the heating zone 44 from the cladding tube interior through a tube wall 46 to the external surrounding medium M, which is therefore acting as a cooling medium. The temperature conditions and heat flux are chosen in such a way that they correspond to the heating of the fuel rod cladding tube 14 by nuclear fuel in a nuclear reactor. Adjacent above and below the heating zone 44 are unheated and therefore comparatively cooler zones. A silver tube 48, which is in the form of a form-fitting adapter part and ensures firstly an intensive and as loss-free a heat transfer as possible and secondly avoids a “baking together” of the cartridge heater 42 and the fuel rod cladding tube 14, is located between the cladding tube interior wall and the cartridge heater 42.

An electrode potential of the fuel rod cladding tube 14 acting as an electrode is a measurement variable which is especially suitable for the assessment of corrosion behavior. The above-mentioned construction of the test and measurement device 2 makes it possible for the electrode potential to be measured in an operation-oriented way at relatively high pressure and high temperature of the surrounding cooling medium and at different water chemistry conditions. The electrically insulating holder of the fuel rod cladding tube 14 inside the Teflon encasing 24 prevents uncontrollable potential changes which impede the evaluation of the measured values. For the same reason, non-illustrated heating coils located inside the cartridge heater 42 are galvanically decoupled from a primary heating electric circuit 51 through one or a series connection of isolating transformers 53. The electrode potential of the fuel rod cladding tube 14 is tapped off by a connecting contact 50 which is connected to the portion of the fuel rod cladding tube 14 which protrudes out of the pressure vessel 4 or out of the insertion piece 10. Since the metallic surface of the cartridge heater 42 is connected in an electrically conductive manner to the fuel rod cladding tube 14 through the silver tube 48, that is to say is at the same potential, the connecting contact 50, as illustrated in FIG. 1, can also be attached to the cartridge heater 42. Furthermore, the insertion piece 10 is cooled on its outside by a cooling device 52 which circulates a coolant. This prevents the Teflon insert 24 from-heating up to too great an extent during operation and from losing its sealing action as result of flowing of the Teflon.

Since the electrode potential can only ever be measured relative to a reference electrode, a plurality of such reference electrodes 54 are furthermore disposed in the interior of the pressure vessel 4, of which one is illustrated diagrammatically in FIG. 1. Connecting lines 56, which are guided through the vessel cover 8, are electrically insulated from the latter. Aperture openings through which the cable is intended to be guided are sealed off in this case, in the manner of a pinched connection, using a temperature-resistant, electrically insulating plastic. It is also possible to use the vessel wall 6 itself as a reference electrode. The electric voltage is in each case measured between the fuel rod cladding tube 14 acting as working electrode and one of the reference electrodes 54, such as by a potential measurement appliance 55 positioned outside the pressure vessel 4 and connected to the electrical connecting contact 50 and the reference electrode 54.

Finally, a plurality of thermocouples 60 are attached to a perpendicular carrier rod 58, which is attached near the surrounding medium outlet 32, and detect an outlet-side temperature profile (based on the height or the longitudinal extent of the fuel rod cladding tube 14) and thus the influence of the tube heating on the temperature of the surrounding medium M. Signal lines connected to the thermocouples 60 are likewise electrically insulated with respect-to the vessel wall 6.

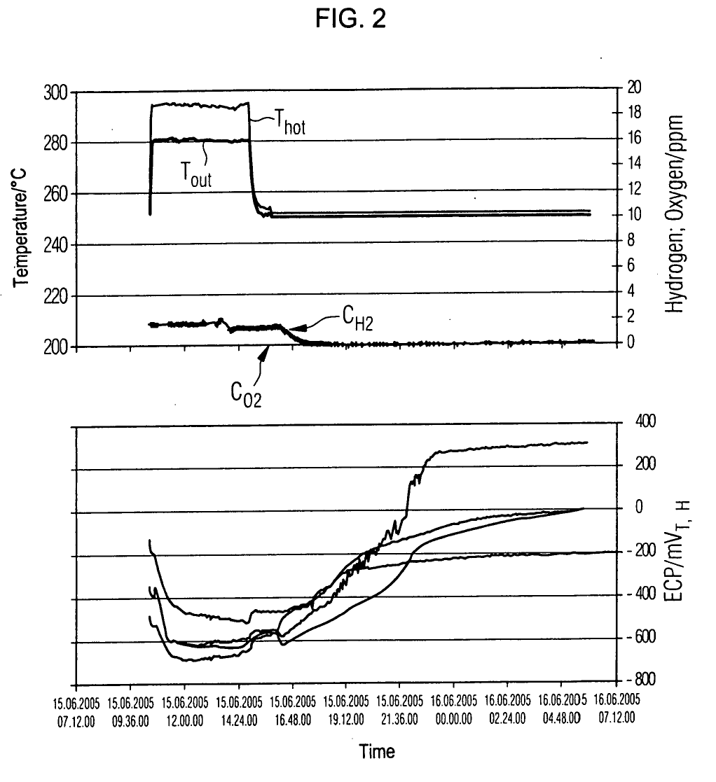

In FIG. 2, the results of measurements taken over a period of 24 h at a fuel rod cladding tube 14 made of zirconium are illustrated by way of example. An upper diagram shows firstly a temperature profile inside the heating zone 44, i.e. a hotfinger temperature Tₕₒₜ and an outlet-side temperature Tout of the surrounding medium M, as a function of time. The ordinate label on the left-hand side in the diagram applies to both of these curves. The fuel rod cladding tube was heated to an approximately constant temperature of about 295° C. within a period from around 10:00 a.m. to 3:00 p.m on the day of measurement, as a result of which the outlet temperature Tₒᵤₜ of the surrounding medium M settled at around 290° C. The heating apparatus 40 was then switched off and at the same time the value of the inlet temperature Tin, determined by preheating the medium M, was turned down from initially 280° C. to 250° C. As a result, the outlet-side temperature Tₒᵤₜ of the surrounding medium M also fell to a value of around 250° C. Secondly, a temporal profile of an oxygen concentration c_{O2} and a hydrogen concentration C_{H2} (measured in ppm) prevailing in the surrounding medium M were also plotted in the same diagram. The right-hand ordinate applies in this case. During the tube heating phase, hydrogen was introduced into the surrounding medium M with the result that the concentration of the hydrogen in relation to the oxygen increased. After heating, the value of the hydrogen concentration quickly decreased again.

The lower diagram of FIG. 2 shows the profile of the electrode potential (ECP), measured in mV, present at the fuel rod cladding tube 14 for the same period of time as in the diagram above. In this case, four different potential profiles, respectively measured in relation to different reference electrodes 54, were recorded simultaneously. Measurement curves of this type can be used by the knowledgeable expert to draw conclusions as to which cladding tube material is better protected under specific surrounding conditions than others and is thus particularly suitable for use in a nuclear reactor.

We claim:

1. A method for testing a fuel rod cladding tube, the method comprising the following steps:
partly immersing the fuel rod cladding tube in a surrounding medium;
heating the fuel rod cladding tube from inside the fuel rod cladding tube;
measuring an electrode potential of the fuel rod cladding tube relative to a reference electrode and providing measured data; and
extrapolating material characteristics in the form of corrosion characteristics of the fuel rod cladding tube using the measured data.

2. The method according to claim 1, which further comprises choosing a chemical composition of the surrounding medium to be the same as, or similar to, a composition of cooling medium in a nuclear reactor.

3. The method according to claim 1, which further comprises choosing an aqueous liquid as the surrounding medium, and introducing into the aqueous liquid one or more gases also being present, or possibly occurring, in a cooling medium during operation of a nuclear reactor.

4. The method according to claim 1, which further comprises selecting a pressure and a temperature of the surrounding medium to correspond to operational conditions in a reactor pressure vessel of a nuclear reactor.

5. The method according to claim 1, which further comprises creating a flow of the surrounding medium recreating flow conditions at a fuel rod cladding tube of a nuclear reactor.

6. The method according to claim 1, which further comprises carrying out the heating step with a heating apparatus heating the fuel rod cladding tube from inside, and selecting a heating power of the heating apparatus to correspond to a heating power released during operation of a nuclear reactor by a nuclear fuel located inside a fuel rod cladding tube.

7. A device for measuring an electrode potential of a fuel rod cladding tube, the device comprising: a pressure vessel to be filled with a surrounding medium,
said pressure vessel having a vessel wall with an aperture opening formed in said vessel wall for insertion of the fuel
rod cladding tube through said aperture opening into said pressure vessel;
a heating apparatus to be disposed in an interior of the fuel rod cladding tube; and
an electrically insulating sealing body to be disposed between the fuel rod cladding tube and said vessel wall.

8. The device according to claim 7, wherein said sealing body is an annular or hollow-cylindrical polytetrafluoroethylene insert.

9. The device according to claim 7, which further comprises an isolating transformer or a series connection of isolating transformers galvanically decoupling said heating apparatus from a primary heating electric circuit.

10. The device according to claim 7, which further comprises an electrical connecting contact to be fixed to the fuel rod cladding tube, a reference electrode disposed in an interior of said pressure vessel and associated with said connecting contact for potential measurement purposes, and a potential measurement appliance positioned outside said pressure vessel and connected to said electrical connecting contact and said reference electrode.

11. The device according to claim 10, wherein said connecting contact is to be fixed to a portion of the fuel rod cladding tube protruding out of said pressure vessel.

12. The device according to claim 7, wherein said heating apparatus is a cartridge heater to be replaceably inserted into the fuel rod cladding tube.

13. The device according to claim 12, wherein said cartridge heater is a high-power cartridge heater having a design output of approximately 75 watts/cm².

14. The device according to claim 12, which further comprises a silver insert constructed as a hollow cylinder or a tube to be disposed between said cartridge heater and the fuel rod cladding tube.

15. The device according to claim 7, wherein said pressure vessel has a flow-side inlet and an outlet for the surrounding medium flowing around the fuel rod cladding tube.

16. The device according to claim 7, which further comprises a number of temperature measuring sensors to be distributed along the fuel rod cladding tube in an interior of said pressure vessel.

17. The device according to claim 16, wherein said temperature measuring sensors are electrically insulated from said pressure vessel and the fuel rod cladding tube.

18. The device according to claim 17, which further comprises further measuring sensors disposed in the interior of said pressure vessel and electrically insulated from said pressure vessel and the fuel rod cladding tube.

19. The device according to claim 7, which further comprises measuring sensors disposed in an interior of said pressure vessel and electrically insulated from said pressure vessel and the fuel rod cladding tube.
